(19) United States
(12) Patent Application Publication
(10) Pub. No.: US 2009/0310367 A1
(43) Pub. Date: Dec. 17, 2009

(54) COMPOSITE LIGHT GUIDE STRUCTURE

(76) Inventor: Shih-Yuan Kuo, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/141,057

(22) Filed: Jun. 17, 2008

(51) Int. Cl. F21V 1/00

(52) U.S. Cl. 362/317

(57) ABSTRACT

A composite light guide structure includes a first light guide plate, a second light guide plate and an optical microstructure. The optical microstructure is disposed between the first light guide plate and the second light guide plate, wherein the material of the first light guide plate is different from that of the second light guide plate.

### BACKGROUND OF THE INVENTION

1. Field of the Invention

The present invention relates to a light guide structure, and more particularly, to a composite light guide structure having a first light guide plate and a second light guide plate.

2. Description of the Prior Art

In general, the light-emitting device for the key modules of the conventional hand-held apparatus (e.g., mobile phone) comprises a light guide plate, a light source and a reflector. The light guide plate is disposed on the reflector, which is commonly made of polyester (PET). However, a PET reflector and light guide plate made of silicone compound are easily attracted to each other. This attracting effect results in the light emitting devices exhibiting an unstable optical phenomenon, causing high variability for the final product, a hand-held apparatus with key module.

### SUMMARY OF THE INVENTION

It is therefore one of the objectives of the present invention to provide a light guide structure, which integrates two different materials to improve the absorbing effect between the reflector and light guide plate, in order to solve the above-mentioned problem.

According to an exemplary embodiment of the present invention, a composite light guide structure is provided. The composite light guide structure comprises a first light guide plate, a second light guide plate and an optical microstructure. The optical microstructure is disposed between the first light guide plate and the second light guide plate. In addition, the material of the first light guide plate is different from the material of the second light guide plate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a composite light guide structure according to an embodiment of the present invention.

### DETAILED DESCRIPTION

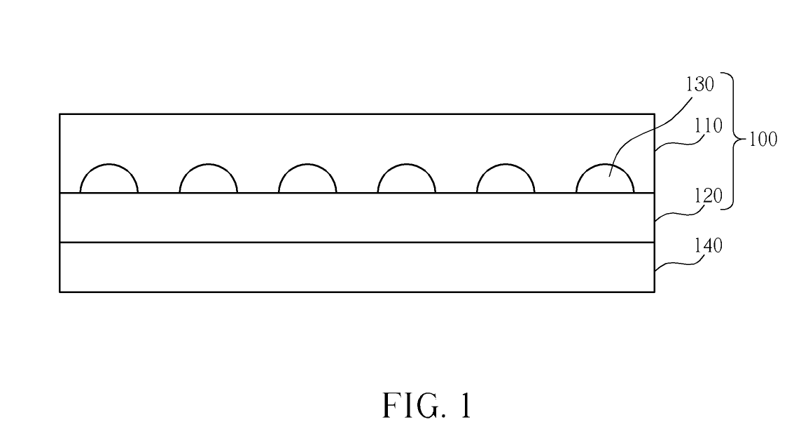

Please refer to FIG. 1. FIG. 1 is a diagram illustrating a composite light guide structure 100 according to an embodiment of the present invention. As shown in FIG. 1, the composite light guide structure 100 comprises a first light guide plate 110, a second light guide plate 120 and an optical microstructure 130. The optical microstructure 130 is disposed between the first light guide plate 110 and the second light guide plate 120. When a light beam enters the composite light guide structure 100, the light beam can be guided out of the composite light guide structure 100 through the optical microstructure 130. In addition, the material of the first light guide plate 110 is different from the material of the second light guide plate 120. Further description of the composite light guide structure 100 is detailed as follows; however, this description is merely for greater clarity of understanding, and should not be taken as limiting the present invention.

In this embodiment, the composite light guide structure 100 is disposed in a key module of a hand-held apparatus, such as a mobile phone as a light guide plate. This is, however, not a limitation of the present invention, and the composite light guide structure of the present invention can be applied to any apparatus (e.g., back light module of liquid crystal display).

As mentioned above, the material of the first light guide plate 110 is different from the material of the second light guide plate 120. In the composite light guide structure 100 of this embodiment, the material of the first light guide plate 110 is a flexible light guide material, whose hardness and tensile strength are greater than 45 (in Shore hardness) and 5.5*10⁶ Pa respectively. For example, the material of the first light guide plate 110 can be a silicone compound, whose hardness and tensile strength are approximately 60 (in Shore hardness) and 6.7*10⁶ Pa respectively.

In the composite light guide structure 100 of this embodiment, the material of the second light guide plate 120 is a polycarbonate (PC) material, whose hardness and tensile strength are both greater than those of the first light guide plate 110. This is, however, not a limitation of the present invention. In practice, the material of the second light guide plate 120 can be any material that the PET reflector doesn't absorb. For example, the material of the second light guide plate 120 can be a PET material.

When being utilized as a light guide plate in a key module, the composite light guide structure 100 can be in contact with a PET reflector in the key modules via the second light guide plate 120 made of PC/PET. In this way, the composite light guide structure 100 and the PET reflector are not attracted to each other since the PC/PET light guide plate 120 and the PET reflector are not attracted to each other. In addition, the composite light guide structure 100 can have the advantages of a silicone compound light guide plate, such as high luminance.

Furthermore, the thickness of the composite light guide structure 100 is not greater than 0.3 mm. In this embodiment, with only 0.15-0.2 mm for thickness of the first light guide plate 110 (made of silicone compound), the required luminance is reached. Using only 0.05-0.1 mm for the thickness of the second light guide plate 120 (made of PC), the attracting phenomenon between the composite light guide structure 100 and the PET reflector is avoided.

Moreover, in this embodiment, the optical microstructure 130 is an optical reflecting structure and is composed of a plurality of optical reflecting units for reflecting the light beams emitting into the composite light guide structure 100. Specifically, the optical microstructure 130 is utilized to prevent the total reflection from happening in the composite light guide structure 100.

Please note that in the above-mentioned embodiment, the material of the first light guide plate 110 is a flexible light guide material and the material of the second light guide plate 120 is a PC material. This is, however, for illustrative purposes and not a limitation of the present invention. In other embodiments, the materials of the first and second light guide plates of the composite light guide structure can be any two different materials depending on design requirements. This alternative design also falls within the scope of the present invention.

Compared with the prior art, the composite light guide structure of the present invention combines two light guide plates that use different materials. The two light guide plates can compensate for each other, so that the composite light guide structure can have better optical characteristics.

Those skilled in the art will readily observe that numerous modifications and alterations of the device and method may be made while retaining the teachings of the invention. Accordingly, the above disclosure should be construed as limited only by the metes and bounds of the appended claims.

1. The apparatus of claim 10, wherein the light guide structure is a composite light guide structure, and the light guide structure further comprises:
another light guide plate; and
an optical microstructure, disposed between the another light guide plate and the light guide plate;
wherein a material of the another light guide plate is different from a material of the light guide plate.

2. The apparatus of claim 1, wherein the material of the another light guide plate is a flexible light guide material.

3. The apparatus of claim 2, wherein the flexible light guide material is a silicone compound.

4. The apparatus of claim 2, wherein a hardness of the another light guide plate is greater than 45 (in Shore hardness).

5. The apparatus of claim 4, wherein the hardness of the another light guide plate ranges between 50 and 70 (in Shore hardness).

6. The apparatus of claim 2, wherein a tensile strength of the another light guide plate is greater than 5.5*106 Pa.

7. The apparatus of claim 6, wherein the tensile strength of the another light guide plate ranges between 6*106 and 8*106 Pa.

8. The apparatus of claim 4, wherein the material of the light guide plate is a polycarbonate (PC) material.

9. The apparatus of claim 1, wherein the material of the another light guide plate is a flexible light guide material, and the material of the light guide plate is a polyester (PET) material.

10. An apparatus, comprising:
a light guide structure, comprising a light guide plate; and
a reflector, placed under the light guide plate,
wherein the light guide structure and the reflector are not attracted to each other based on material properties of the light guide plate and the reflector.

11. The apparatus of claim 10, wherein the material of the reflector is a polyester (PET) material, and the material of the light guide plate is a polyester (PET) material or a polycarbonate (PC) material.
